(19) United States
(12) Patent Application Publication
(10) Pub. No.: US 2007/0204646 A1
(43) Pub. Date: Sep. 6, 2007

(54) Cold plate incorporating a heat pipe

(76) Inventor: Thomas Gagliano, Fountain Vly, CA (US)

Correspondence Address: MICHAEL BEST & FRIEDRICH, LLP, 100 E WISCONSIN AVENUE, Suite 3300, MILWAUKEE, WI, 53202, US

(21) Appl. No.: 11/365,767

(22) Filed: Mar. 1, 2006

(51) Int. Cl. B67D 5/62; F28D 15/00

(52) U.S. Cl. 62/389; 165/104.21; 222/146.6

(57) ABSTRACT

Apparatus and method for cooling a comestible fluid. The method can include cooling a plate with ice. A heat pipe with a condenser portion can be in heat transfer relationship with the plate, and an evaporator portion can be in heat transfer relationship with the comestible fluid. Heat can be transferred from a comestible fluid to the plate through the heat pipe.

### FIELD OF THE INVENTION

The invention relates to a cold plate for a comestible fluid dispensing apparatus. More specifically, the invention relates to a cold plate incorporating a heat pipe.

### BACKGROUND OF THE INVENTION

Cold plates have been used to cool beverage liquids, most commonly in multi-tap restaurant style dispensers. As shown in FIG. 1, a conventional cold plate 10 has a fluid inlet 14 and a fluid outlet 18 in an aluminum block 22. Between the fluid inlet 14 and the fluid outlet 18 is a stainless steel beverage line 26. The beverage line 26 generally serpentines through the aluminum block 22 to provide a greater length of travel and to increase the cooling ability of the cold plate 10. The heat transfer and thermal capacitance properties of the aluminum block 22 are taken advantage of, while the stainless steel beverage line 26 provides a clean, corrosion-resistant material for contact with a comestible beverage.

A conventional cold plate 10 is generally rather bulky and heavy. While aluminum is a lightweight metal, a large block is required to provide the necessary thermal capacitance to handle acceptable beverage draw rates from a dispenser. Additionally, there is the problem of positioning the stainless steel beverage line 26 within the aluminum block 22. This is usually accomplished by casting the aluminum block 22 over the stainless steel beverage line 26. The hot, molten aluminum may warp or displace the stainless steel beverage line 26. This results in difficulty maintaining designed performance or the introduction of additional components and complexity in the casting process to ensure correct placement of the beverage line 26 within the aluminum block 22. Often, several stainless steel beverage lines 26 are included in the aluminum block 22, magnifying the problem.

### SUMMARY OF THE INVENTION

Accordingly, a need exists for a cold plate for a beverage dispenser that is sanitary, provides acceptable cooling capacity and draw rates, has a higher effective conduction rate than conventional cold plates, requires fewer raw materials, and has a low-mass.

In one embodiment, the invention provides a cold plate for cooling a dispensable liquid. A plate includes at least one surface for contact with a low temperature heat sink. A heat pipe is in heat transfer relationship with the plate and the dispensable liquid.

In another embodiment, the invention provides a cold plate for cooling comestible fluid. A top plate supports a heat sink and maintains a temperature substantially the same as the heat sink. Heat pipes each include a condenser portion adjacent to the top plate and an evaporator portion substantially opposite the condenser portion. A buffer is positioned between an adjacent pair of heat pipes to define a comestible fluid flow path through the cold plate.

In another embodiment, the invention provides a cold plate for cooling comestible fluid. A plate is in contact with a heat sink. A base is parallel to the plate and is spaced a distance from the plate. Heat pipes are positioned between the plate and the base. One or more heat pipes include upper notches adjacent to the plate and lower notches adjacent to the base. The upper notches and the lower notches define at least part of a comestible fluid flow path through the cold plate.

In another embodiment, the invention provides a cold plate for cooling a comestible fluid. A top plate is ice-cooled. A second plate is located a distance below the top plate and is substantially parallel to the top plate. A comestible fluid passage is between the top plate and the second plate. At least one heat pipe has at least a portion in heat transfer relationship with the top plate and the second plate.

In another embodiment, the invention provides a cold plate for cooling a comestible fluid. A top plate is ice-cooled. A molded block is positioned below the top plate. A comestible fluid flow passage is formed in the molded block. At least one heat pipe is in heat transfer relationship with the top plate and the molded block.

In another embodiment, the invention provides a cold plate for cooling a comestible fluid. A plate is in contact with a heat sink. A chamber is partially defined by the plate. A liquid is contained within the chamber. A comestible fluid line is positioned at least partially within the chamber. A heat pipe is positioned to transfer heat from the comestible fluid to the plate via the liquid.

In another embodiment, the invention provides a beverage dispenser for cooling a comestible fluid and dispensing at least one liquid beverage containing the comestible fluid. An interior volume contains ice. A cold plate is positioned at least partially within the interior volume. The cold plate includes a heat pipe to exchange heat energy between the comestible fluid and the ice. At least one dispense head is provided for dispensing the liquid beverage.

In another embodiment, the invention provides a method of cooling a comestible fluid. A first plate is cooled with ice. A heat pipe is provided with a condenser portion adjacent the first plate and an evaporator portion adjacent the comestible fluid such that the heat pipe draws heat energy from the comestible fluid into at least one of the first plate and the ice.

Other aspects of the invention will become apparent by consideration of the detailed description and accompanying drawings.

### BRIEF DESCRIPTION OF THE DRAWINGS

FIG. 1 is a perspective view of a cold plate of the prior art;

FIG. 2 is a schematic view of a heat pipe;

FIG. 3 is a perspective view of a cold plate according to one embodiment of the invention;

FIG. 4 is an exploded view of the cold plate of FIG. 3;

FIG. 5 is a partial perspective view of the cold plate of FIGS. 3 and 4;

FIG. 6 is a partial cross-sectional view of the cold plate of FIGS. 3-5;

FIG. 7 is a perspective view of a cold plate according to another embodiment of the invention;

FIG. 8 is another perspective view of the cold plate of FIG. 7;

FIG. 9 is a partial cross-sectional view of the cold plate of FIGS. 7 and 8;

FIG. 10A is an exploded perspective view of a cold plate according to another embodiment of the invention;

FIG. 10B is a partial cross-sectional view of the cold plate of FIG. 10A;

FIG. 11 is a perspective view of a cold plate according to another embodiment of the invention;

FIG. 12 is a front view of the cold plate of FIG. 11;

FIG. 13A is a schematic cross-sectional view of one heat pipe configuration for the cold plate of FIGS. 11 and 12;

FIG. 13B is a schematic cross-sectional view of another heat pipe configuration for the cold plate of FIGS. 11 and 12;

FIG. 13C is a perspective view of another heat pipe configuration for a cold plate similar to that shown in FIGS. 11 and 12;

FIG. 14A is a perspective view of a cold plate according to another embodiment of the invention;

FIG. 14B is a perspective view of a cold plate according to another embodiment of the invention;

FIG. 15A is an end view of the cold plate of FIG. 14A;

FIG. 15B is an end view of the cold plate of FIG. 14B;

FIG. 16 is a partial perspective view of a cold plate according to another embodiment of the invention;

FIG. 17 is a perspective view of the cold plate of FIG. 16 with the bottom plate removed for clarity;

FIG. 18 is a perspective view of a cold plate according to another embodiment of the invention; and

FIG. 19 is a perspective view of a beverage dispensing system including a cold plate according to one of the embodiments of the invention.

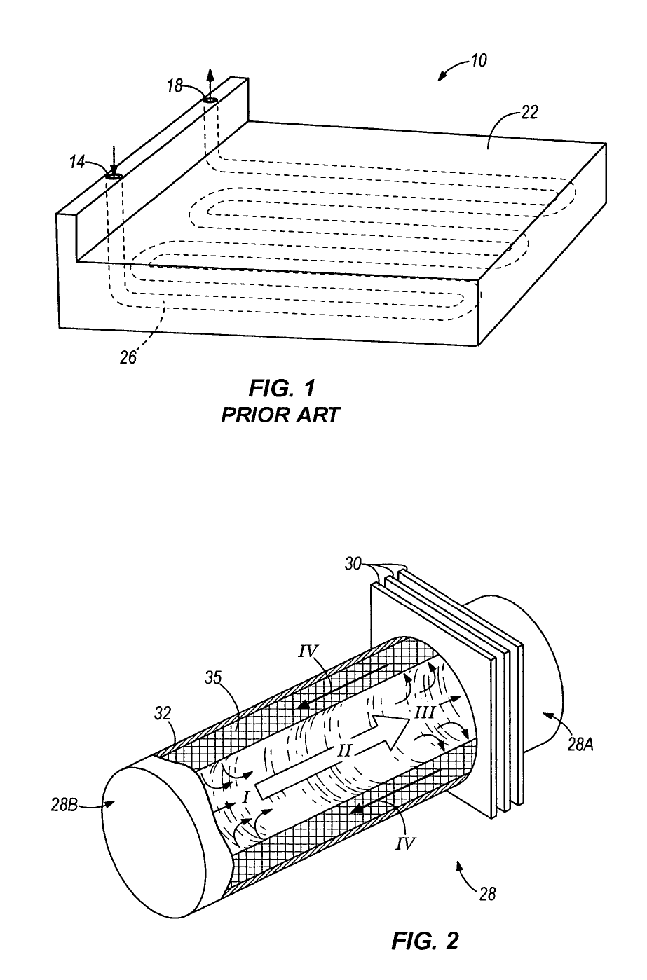

### DETAILED DESCRIPTION OF THE INVENTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

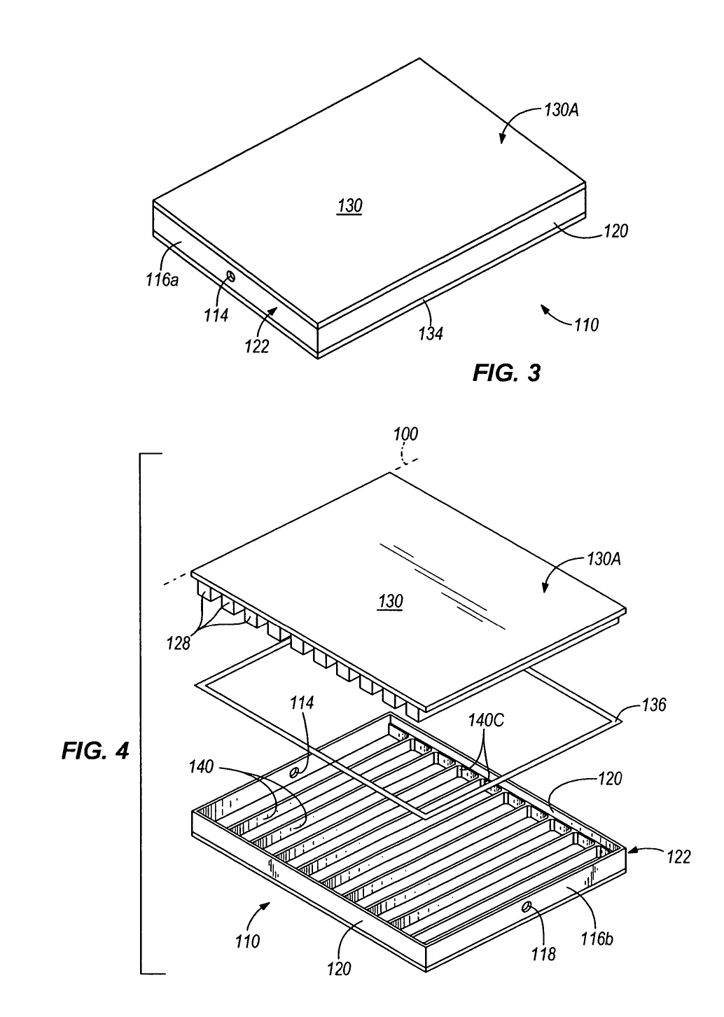

A heat pipe 28, as shown in FIG. 2, can have a condenser portion 28A and an evaporator portion 28B. The condenser portion 28A of the heat pipe 28 can be provided with fins 30 to aid in dissipating the heat supplied at the evaporator portion 28B, but fins 30 are not required. In some applications, fins 30 can also or alternatively be used on the evaporator portion 28B to provide greater heat absorbing area. In a cooling or chilling application, the evaporator portion 28B can be positioned adjacent a heat source and the condenser portion 28A can be positioned adjacent a heat sink.

A heat pipe takes advantage of the latent heat energy in a phase change from liquid to gas or vice versa to efficiently transfer large amounts of heat energy with little thermal resistance. The heat pipe 28 has a vessel wall 32 defining an interior volume of the heat pipe 28, which is typically evacuated of atmosphere before it is back-filled with a heat pipe fluid. Common heat pipe fluids are water, methanol, ammonia, and acetone, among others. Inside the vessel wall 32 is a wick structure 35. The wick structure 35 is generally shaped with an outer portion conforming to the vessel wall 32 and an open interior cavity. The heat pipe 28 is back-filled with just enough heat pipe fluid to saturate the wick structure 35. A heat pipe fluid is selected with a boiling point between the heat source temperature and the heat sink temperature. When exposed to heat, the heat pipe fluid at the evaporator portion 28B boils and evaporates from the wick structure 35 (as shown by arrows I), creating a relatively small positive pressure in the evaporator portion 28B. The vaporous heat pipe fluid is then at a state of energy higher than it was as a liquid, due at least to the latent heat of vaporization (and a possible temperature increase). The vaporous heat pipe fluid moves (as shown by arrow II) to a colder section of the heat pipe 28, namely the condenser portion 28A, where it condenses (as shown by arrows III) on the wick structure 35, yielding the latent heat energy gained in evaporation. Heat energy is thereby transferred from the evaporator portion 28B to the condenser portion 28A and ultimately to a heat sink in contact with the condenser portion 28A. Once condensed at the wick structure 35 of the condenser portion 28A, the heat pipe fluid travels (as shown by arrows IV) by capillary action back to a location of the wick structure 35 in the evaporator portion 28B, which completes the cycle.

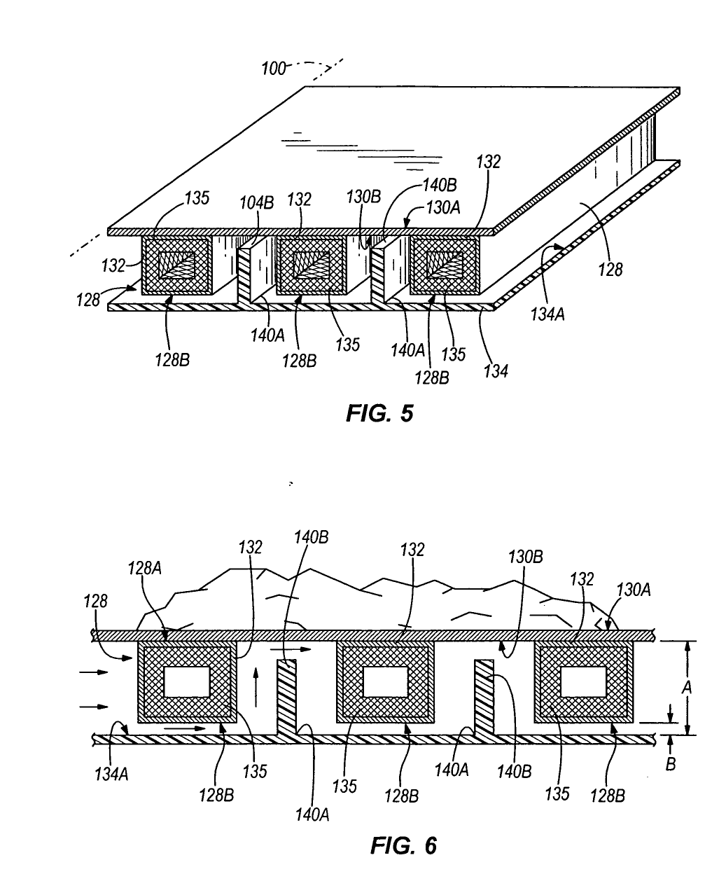

FIGS. 3-6 illustrate a cold plate 110 with heat pipes 128 according to one embodiment of the invention. The cold plate 110 can have a fluid inlet 114 positioned in a first side wall 116a and a fluid outlet 118 positioned in a second side wall 116b (as shown in FIG. 4) opposite the fluid inlet 114. The cold plate 110 can include a bottom plate or base 134 and two end walls 120 between the side walls 116 to define a case 122. As shown in FIG. 4, several heat pipes 128 can be positioned between a top plate 130 and the bottom plate 134 of the cold plate 110. As shown in FIG. 6, the top and bottom plates 130, 134 can be spaced apart a distance A. In some embodiments, each heat pipe 128 can have a rectangular cross-section and can be elongated parallel to an axis 100, as shown in FIGS. 4 and 5. The top plate 130 can have an upper surface 130A in contact with a quantity of ice, such that the top plate 130 is ice-cooled. As shown in FIG. 6, each heat pipe 128 can have an upper surface 128A coupled to a lower surface 130B of the top plate 130. The upper surface 128A can be the condensing portion (i.e., the condenser portion) of the heat pipe 128 as it is nearest a heat sink (e.g., the quantity of ice on the top plate 130). In some embodiments, each heat pipe 128 has a vessel wall 132 (e.g., a stainless steel vessel wall) to provide a sanitary, corrosion-resistant material for contact with comestible fluids. A wick structure 135 can be positioned within the vessel wall 132. As shown in FIG. 4, a gasket 136 can be positioned between the lower surface 130B of the top plate 130 and the side and end walls 116, 120, along a periphery of the top plate 130 in order to seal the case 122. In some embodiments, the bottom plate 134 can be permanently attached to the side and end walls 116, 120, eliminating the need for an additional gasket.

The height of the heat pipes 128, as shown in FIG. 6, can be less than the distance A between the top and bottom plates 130, 134, leaving a distance B between an upper surface 134A of the bottom plate 134 and a lower surface 128B of each heat pipe 128, along the length of each heat pipe 128. The distance B can form part of a comestible fluid flow path between the fluid inlet 114 and the fluid outlet 118 of the cold plate 110. As a result of a ratio of the distance B to the distance A being relatively small, a substantial increase in fluid velocity can be experienced in the region between the bottom plate 134 and each of the heat pipes 128. This can provide an increased Reynolds Number indicating greater turbulence, and thus, an increased convection heat transfer coefficient between the flow of comestible fluid and the lower surface 128B of each of the heat pipes 128. The lower surface 128B can be the evaporating portion (i.e., the evaporator portion) of the heat pipe 128 as it can be in contact with the comestible fluid from which heat is to be extracted. Evaporated heat pipe fluid can travel between the lower surface 128B and the upper surface 128A. Some evaporating and condensing may also occur in the intermediate region between the upper surface 128A and the lower surface 128B.

As shown in FIGS. 4-6, a baffle 140 can be positioned between adjacent heat pipes 128 and can, in some embodiments, extend the full length of the heat pipes 128. As shown in FIGS. 5 and 6, the baffles 140 can have proximal edges 140A adjacent the bottom plate 134 and distal edges 140B extending toward the top plate 130, but leaving a space between the distal edges 140B and the lower surface 130B of the top plate 130. The baffles 140 being positioned between the heat pipes 128 can further define the comestible fluid flow path, and can define the flow path to be serpentine, as the comestible fluid must make several turns of about 180 degrees to flow from the fluid inlet 114 to the fluid outlet 118 of the cold plate 110. The baffles 140 can also induce turbulence to increase the convection heat transfer capability between the comestible fluid, the heat pipes 128, and the top plate 130. As shown in FIG. 4, each baffle 140 can be supported at ends 140C by the end walls 120 of the case 122. In other embodiments, the baffles 140 can be supported by the bottom plate 134 or formed integrally with the end walls 120 and/or the bottom plate 134. The baffles 140 can be constructed of one or more materials suitable for contact with comestible fluids. In some embodiments, the baffles 140 and the case 122 can be integrally molded as a single plastic piece. As described in detail below, the baffles 140 can also be constructed at least partially of flavored syrup lines.

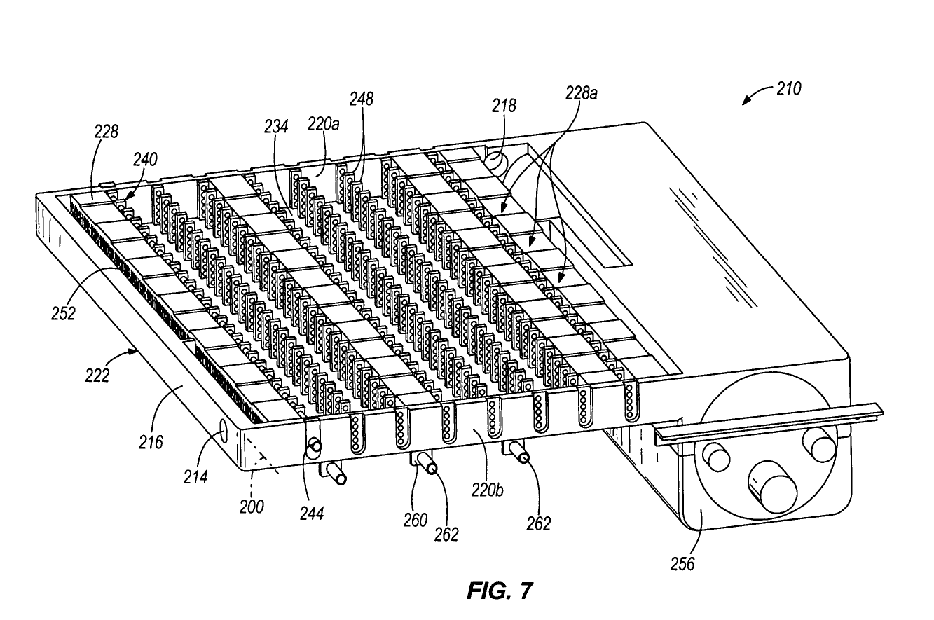

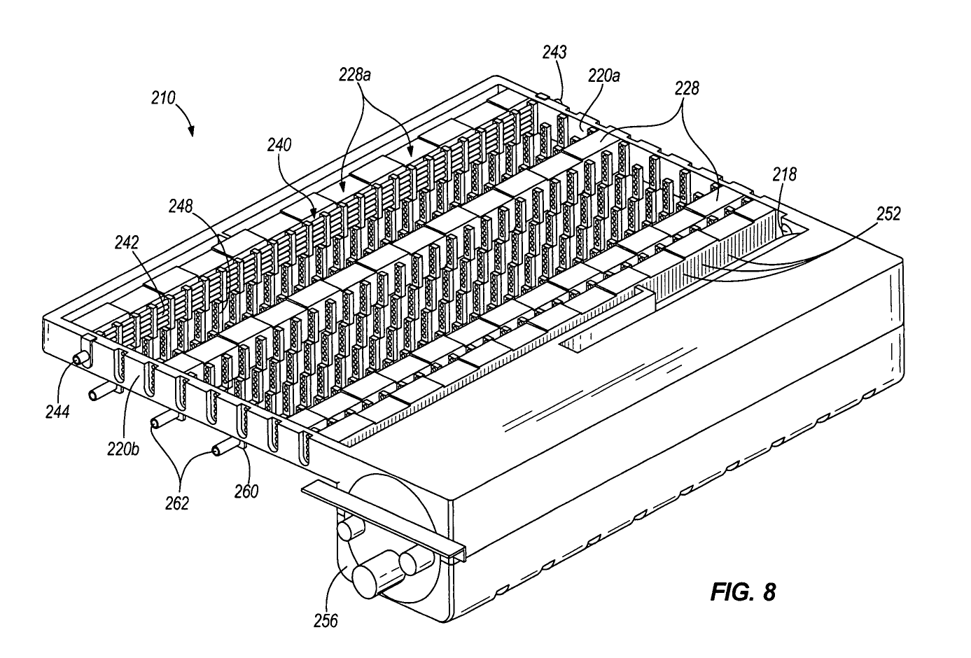

FIGS. 7-9 illustrate a cold plate 210 according to another embodiment of the invention. The cold plate 210 can include baffles 240 between adjacent heat pipes 228. The baffles 240 can be substantially formed of parallel syrup lines 242, which can extend parallel to an axis 200 (as shown in FIG. 7). The syrup lines 242 can contain flavored syrups for mixing with the comestible fluid, which can be carbonated or non-carbonated drinking water. By providing the syrup lines 242 in the baffles 240, the syrup can be cooled by the comestible fluid, while also providing a serpentine flow path for the comestible fluid. In some embodiments, the baffles 240 may not provide a truly serpentine flow path, but rather a substantial flow obstruction between adjacent heat pipes 228 to promote turbulence in the comestible fluid flow. Turbulence can increase the convection heat transfer that occurs between the comestible fluid, the heat pipes 228, and the top plate 230. In FIGS. 7 and 8, the top plate 230 is not shown. The top plate 230 can be similar to that of the other embodiments described herein and can be designed for conducting heat from the comestible fluid inside the cold plate 210 to a heat sink, such as a quantity of ice, on its upper surface 230A.

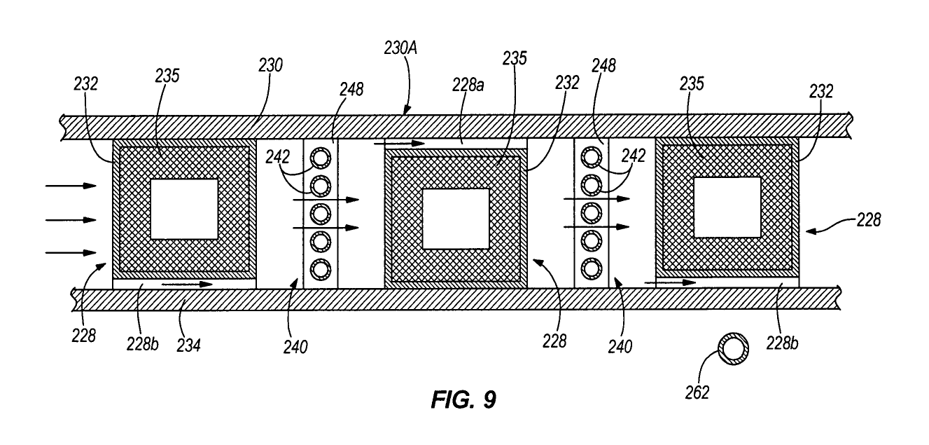

As shown in FIGS. 8 and 9, each baffle 240 can include one or more syrup lines 242 (e.g., groups of several parallel syrup lines 242). Each group of syrup lines 242 in a baffle 240 can have a common syrup inlet 243 in a first end wall 220a and a common syrup outlet 244 in a second end wall 220b opposite the first end wall 220a. Each of the syrup lines 242 in a group can be spaced apart a small distance from the other syrup lines 242 in the group using one or more spacer plates 248. Alternately, each syrup line 242 in a group can be joined with each adjacent syrup line 242 in the group to eliminate the gaps therebetween. Groups of syrup lines 242 can be positioned in a suitable number and/or shape between adjacent heat pipes 228. Furthermore, in some embodiments, one or more groups of syrup lines 242 can include a single serpentine syrup line 242, rather than separate parallel syrup lines 242. Various configurations, some of which are suggested above, provide flexibility in chilling performance and beverage flavor variety for the cold plate 210 and associated dispenser.

As shown in FIGS. 7-9, the cold plate 210 can include a case 222 with two side walls 216, two end walls 220a and 220b, and a base (or bottom plate) 234. The case 222 can be molded of plastic as one piece with the side walls 216, the end walls 220a and 220b, and the base 234. The spacer plates 248 can extend from the base 234. In some embodiments, the spacer plates 248 can be integrally molded as one piece with the base 234.

As shown in FIG. 7, a comestible fluid inlet 214 can be positioned in one of the side walls 216 and a comestible fluid outlet 218 can be positioned in the end wall 220a of the case 222. In some embodiments, the heat pipes 228 can include ridges or fins 252 (as shown in FIGS. 7 and 8) on their vessel walls 232 to provide increased surface area for heat transfer with the comestible fluid in the case 222. The ridges or fins 252 can also promote turbulence. Furthermore, in some embodiments, the cold plate 210 can include a carbonator module 256 (as shown in FIGS. 7 and 8) for providing carbonation in the comestible fluid after the comestible fluid is chilled in the cold plate 210.

FIGS. 7-9 illustrate heat pipes 228 with a “notched” construction along their length. Each heat pipe 228 can be sectioned into a series of alternating high portions and low portions. When assembled with the top plate 230, each high portion can include a top surface abutting the top plate 230 and each low portion can include a bottom surface abutting the base 234 of the case 222. This can create a series of spaced-apart notches 228a along the upper side of the heat pipe 228 and a series of spaced-apart notches 228b along the lower side of the heat pipe 228. The notches 228a are located at the top surface of the low portions between adjacent high portions. Similarly, the notches 228b are located at the bottom surface of the high portions between adjacent low portions. Various other constructions for providing spaced-apart notches can be used in alternate embodiments of the invention. The upper notches 228a and lower notches 228b provide a series of relatively narrow flow paths for the comestible fluid flowing through the cold plate 210. As shown in FIG. 9 (and assuming that the leftmost heat pipe 228 is the closest to the comestible fluid inlet 214), comestible fluid enters with substantially horizontal flow from the inlet 214 toward the leftmost heat pipe 228. The narrow flow paths promote contact along the side faces of the heat pipes 228, while simultaneously imparting increased local comestible fluid velocity. In between adjacent heat pipes 228, the flow of comestible fluid can flow past the syrup lines 242, in order to cool the contents of the syrup lines 242. The heat pipes 228 and the syrup lines 242 can be constructed with outer surfaces of materials which are suitable for contact with a comestible fluid. In some embodiments, the heat pipes 228 can be stainless steel and the syrup lines 242 can be plastic.

As shown in FIGS. 7 and 8, ambient temperature syrup lines 262 can be coupled to the underside of the cold plate 210 for providing syrup to a dispense tap (not shown) without significant chilling. This is common for providing ambient temperature syrups, such as iced tea. Three ambient syrup lines 262 are shown in FIGS. 7 and 8, each one coupled to the case 222 by integrally-formed, downwardly-extending tabs 260. This is only one suitable method of attachment of the ambient temperature syrup lines 262 to the cold plate 210.

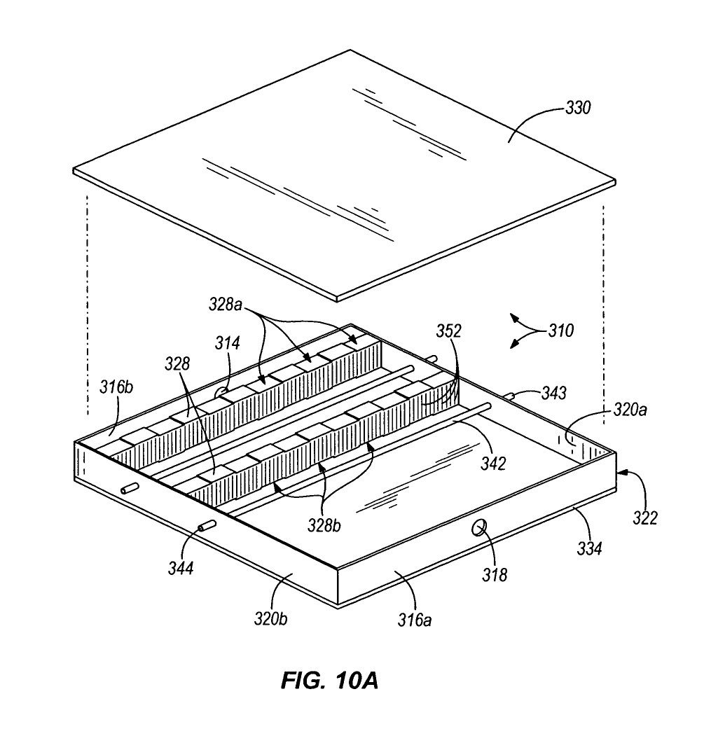

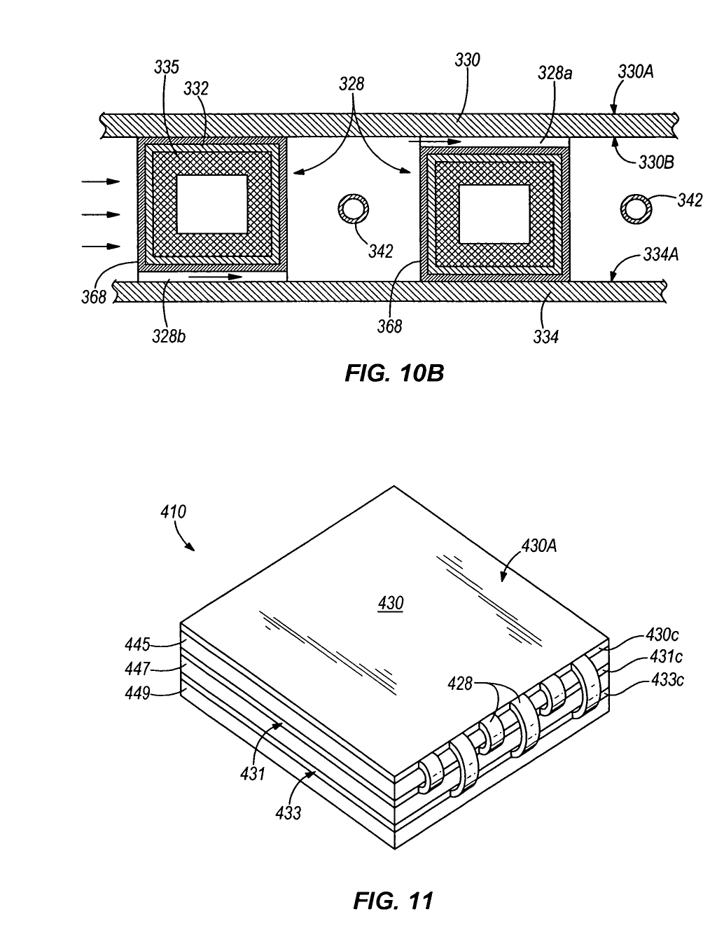

FIGS. 10A and 10B illustrate a cold plate 310 according to another embodiment of the invention. The cold plate 310 can include several heat pipes 328; however, only two heat pipes 328 are shown positioned within a case 322. In some embodiments, the cold plate 310 can include three or more heat pipes 328 positioned within the case 322. Each heat pipe 328 can be constructed as discussed above with reference to FIGS. 7-9 with like parts given similar reference numerals in the 300 series. As shown in FIG. 10A, the cold plate 310 can include a comestible fluid outlet 318 on one side wall 316a. A comestible fluid inlet 314 can be located on another side wall 316b, substantially opposite the comestible fluid outlet 318. In some embodiments, the case 322 can include two end walls 320a and 320b, and each heat pipe 328 can extend between the two end walls 320a and 320b.

A syrup line 342 can be positioned between adjacent heat pipes 328. Each syrup line 342 can extend through both walls 320a and 320b of the case 322, extending substantially parallel to the heat pipes 328 with a syrup inlet 343 at one end wall 320a and a syrup outlet 344 at the opposite end wall 320b. In some embodiments, the syrup lines 342 can be in a serpentine configuration between the two end walls 320a and 320b and can have the syrup inlet 343 and the syrup outlet 344 at the same or opposite end walls. In some embodiments, multiple syrup lines 342 can be positioned between adjacent heat pipes 328. The “under-over” flow of comestible fluid through the cold plate 310 can be substantially the same as shown in FIG. 9 due to spaced-apart notches 328a in an upper surface of the heat pipes 328 and spaced-apart notches 328b in a lower surface of the same.

FIG. 10B illustrates a partial cross-section of the cold plate 310 of FIG. 10A. In some embodiments, each of the heat pipes 328 is overmolded by a layer 368 of plastic or another polymeric material suitable for contact with a comestible fluid. The layer 368 can be relatively thin and/or can be constructed with a material that is heat conductive. The heat pipe 328 may or may not be constructed of a material suitable for contact with a comestible fluid. In some embodiments, the heat pipes 328 are constructed substantially of copper. In some embodiments, the heat pipes 328 can have fins (or ridges) 352 (as shown in FIG. 10A) formed integrally with the vessel wall 332, which can then be overmolded or otherwise covered by the plastic layer 368. In some embodiments, the plastic layer 368 itself can be provided with surface irregularities (i.e., fins, ridges, dimples, etc.) to enhance the surface area and effective heat transfer rate of the plastic layer 368.

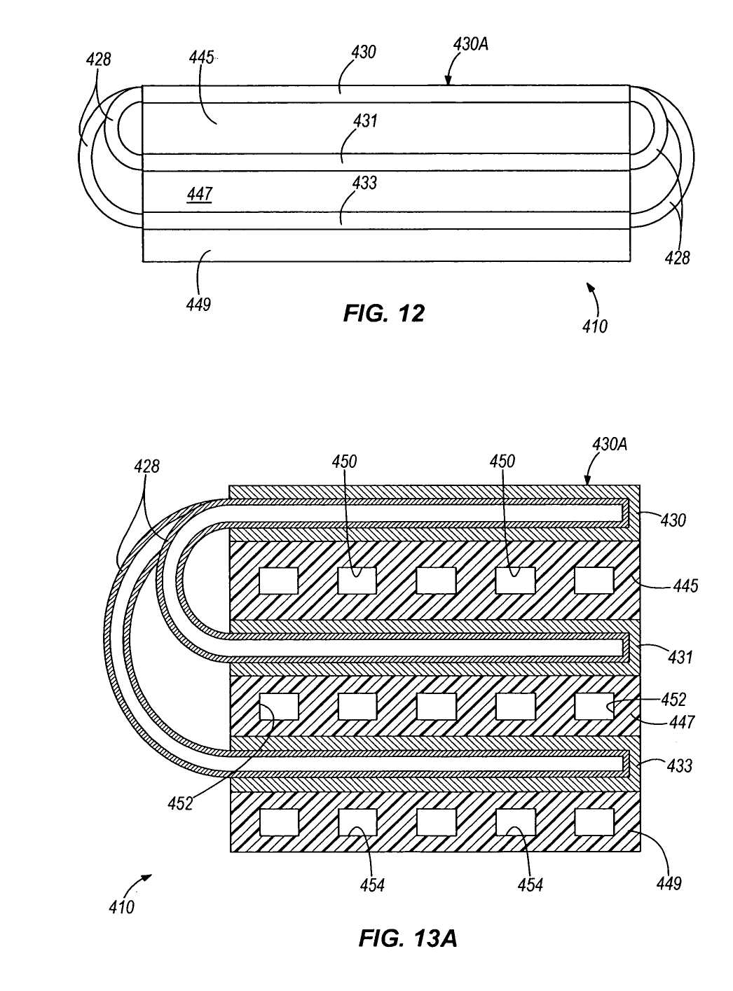

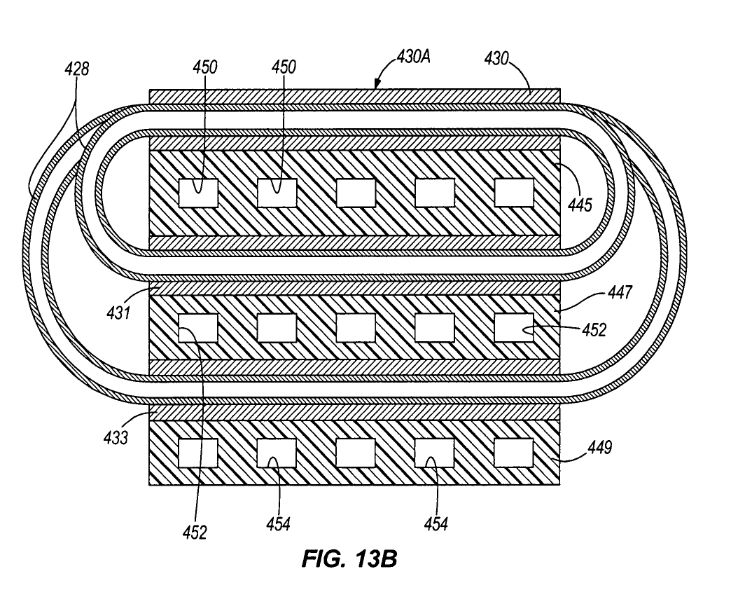

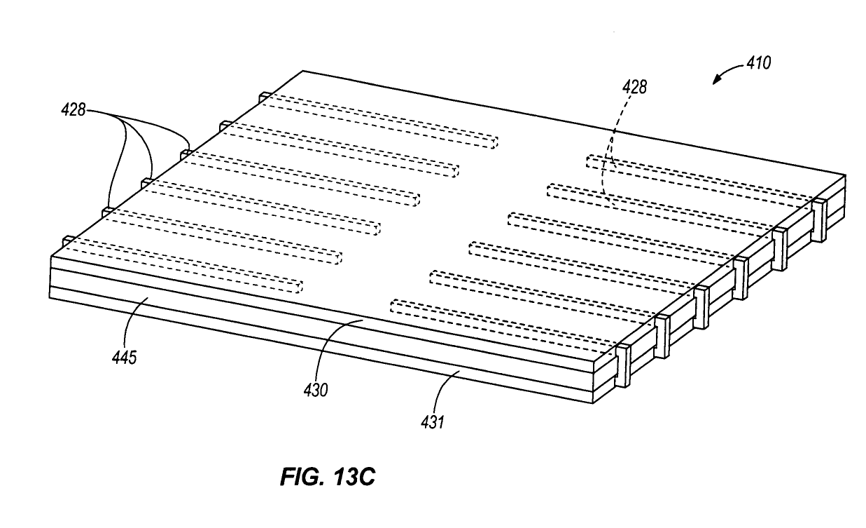

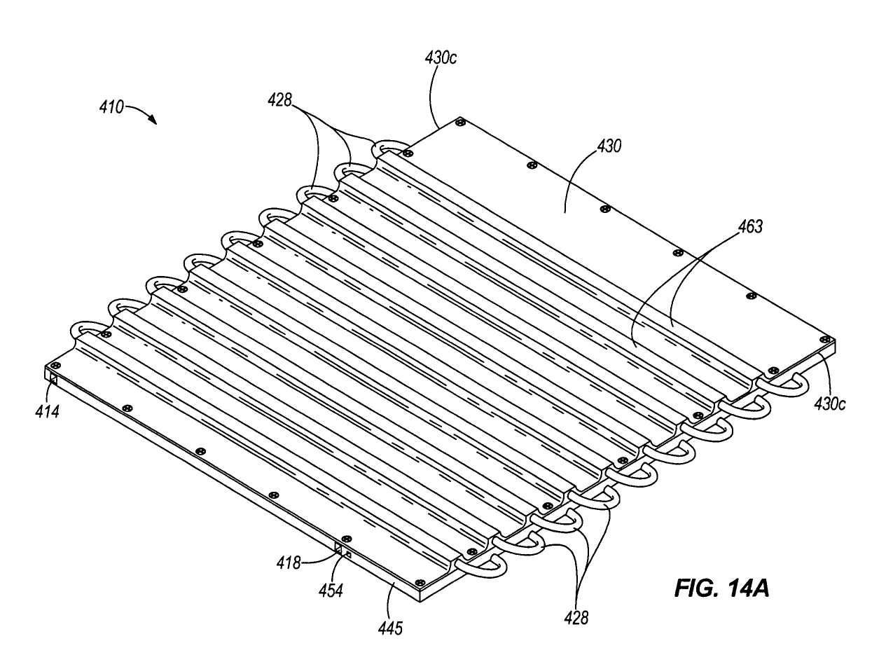

FIGS. 11-13B illustrate a cold plate 410 according to one embodiment of the invention. The cold plate 410 can include heat pipes 428. A top plate 430 can have an upper surface 430A for contact with a heat sink, such as a quantity of ice (e.g., at zero degrees Celsius). The top plate 430 can include two opposed ends 430c defining a length of the top plate 430. A second plate 431 can be spaced a distance below the top plate 430. The second plate 431 can be spaced from the top plate 430 by a first spacer block 445. The first spacer block 445 can be molded of plastic with integral comestible fluid passages (or channels) 450. The comestible fluid passages 450 can be rectangular and can be spaced evenly across the width of the cold plate 410. A first set of heat pipes 428 can connect the top plate 430 and the second plate 431. The wick structures of the heat pipes 428 are not shown in FIGS. 13A and 13B. A condenser portion of each of the first set of heat pipes 428 can be press-fit into one of the ends 430c of the top plate 430, such that the condenser portion can extend across the entire length of the top plate 430. An evaporator portion of each of the first set of heat pipes 428 can be press-fit into an end 431c of the second plate 431, such that the evaporator portion can extend across the entire length of the second plate 431. In some embodiments, each heat pipe 428 can extend from one end 430c of the top plate 430 to the second plate 431, through the second plate 431, and back to the opposite end 430c of the top plate 430, forming a loop (as shown in FIGS. 12 and 13B). In other embodiments, each heat pipe 428 of the first set can extend across at least half the width of the top plate 430 and down from only one end 430c to the second plate 431. In these embodiments, heat pipes 428 can extend from both ends 430c or only one end 430c of the top plate 430. FIG. 13A illustrates heat pipes 428 that extend from a single end 430c of the top plate 430.

As shown in FIGS. 11-13B, a third plate 433 can be spaced a distance below the second plate 431. The third plate 433 can be spaced from the second plate 431 by a second spacer block 447, which can be molded of plastic with integral comestible fluid passages (or channels) 452 (as shown in FIGS. 13A and 13B). A second set of heat pipes 428 can connect the top plate 430 and the third plate 433 in the same manner as described above with respect to the top plate 430 and second plate 431.

In one embodiment, the top plate 430, the second plate 431, and the third plate 433 can each be constructed of aluminum. In one embodiment, each of the heat pipes 428 of the first and second set can be constructed of copper. The comestible fluid passages 450, 452 can be integrally formed in the first and second spacer blocks 445, 447, respectively. The first and second spacer blocks 445, 447 can be molded of a relatively heat-conductive plastic (or a polymeric material containing a heat conductive additive). The configuration of the first and second set of heat pipes 428 between the spacer blocks 445, 447 can provide increased heat transfer capacity compared to a solid block of plastic of similar size. In some embodiments, by connecting the second and third plates 431, 433 to the top plate 430 with heat pipes 428, an isothermal (or relatively isothermal) connection can be obtained between the plates 430, 431, 433 that can keep the temperature of the second and third plates 431, 433 at or very near zero degrees Celsius.

In the embodiments including spacer blocks (as shown in FIGS. 11-13C), the spacer blocks 445, 447, and 449 can be constructed at least partially of a thermal plastic material. The thermal plastic can be an ultra-high molecular weight low temperature thermoplastic, which can have a low resistance to thermal conduction in at least one direction. In some embodiments, the resistance to thermal conduction is significantly lower in one direction than in another orthogonal direction in the thermal plastic material. In some embodiments, the thermal plastic material can be positioned in the cold plate 410 such that the direction of low thermal resistance is orthogonal to the top plate 430 to maximize the thermal conductance of heat from the spacer blocks 445, 447, and 449 to the top plate 430 and/or additional plates which can be connected to the top plate via the heat pipes 428. Such materials and orientations can also be used in combination with cold plates according to other embodiments of the invention to maximize heat transfer effectiveness.

In some embodiments, a third spacer block 449 can be provided beneath the third plate 433. The third spacer block 449 can be molded of plastic with integral syrup passages (or channels) 454 (as shown in FIGS. 13A and 13B). The third spacer block 449 and the syrup contained therein can be chilled by the third plate 433. The chilling effect on the third spacer block 449 can be reduced as compared to the first and second spacer blocks 445, 447 by not positioning the third spacer block 449 between two chilled plates.

Although illustrated and described as solid, aluminum plates, each of the top plate 430, the second plate 431, and the third plate 433 can be constructed of other heat conductive materials or of multiple parts. Similarly, the number of heat pipes 428 in each of the first and second sets can vary, depending on heat pipe performance and space constraints. In some embodiments, the heat pipes 428 can be substantially round and constructed of copper. Heat pipes of other forms and materials can be used in other embodiments.

FIG. 13C illustrates a modified embodiment similar to that of FIGS. 11-13B. The cold plate 410 can include two sets of heat pipes 428, which extend from opposite ends and terminate near the center of the cold plate 410. The spacer block 445 can include a comestible fluid path (not shown), which may be serpentine in some embodiments. The spacer block 445 can be constructed of a polymeric material in some embodiments, such as a thermal plastic. In some embodiments, the spacer block 445 can be a thin plate that allows direct contact between the comestible fluid, the top plate 430, and second plate 431. In some such embodiments, the top plate 430, second plate 431, and spacer block 445 can be at least partially constructed of stainless steel. The cold plate 410 illustrated in FIG. 13C can also be provided with additional spacer blocks and plates as shown in FIGS. 11-13B and described above.

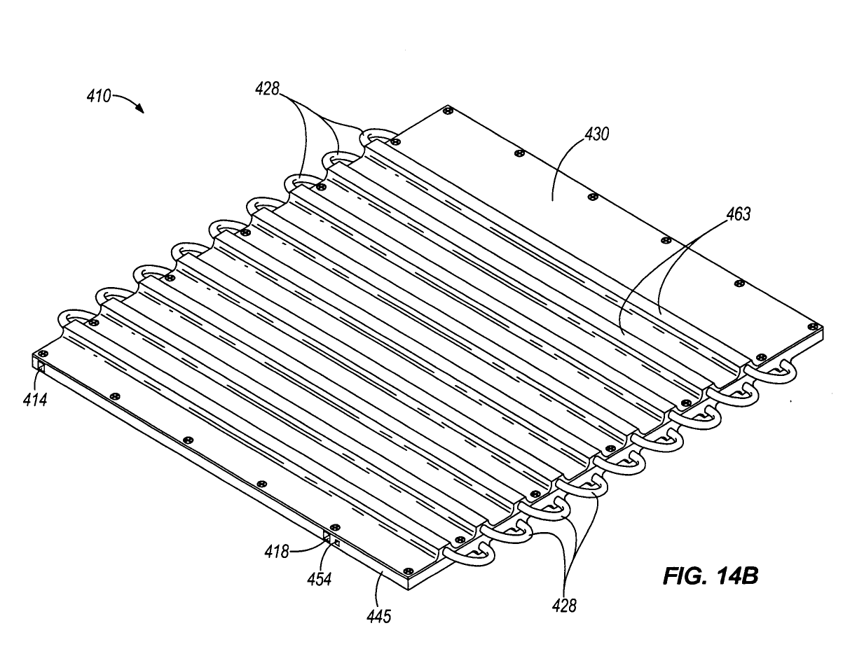

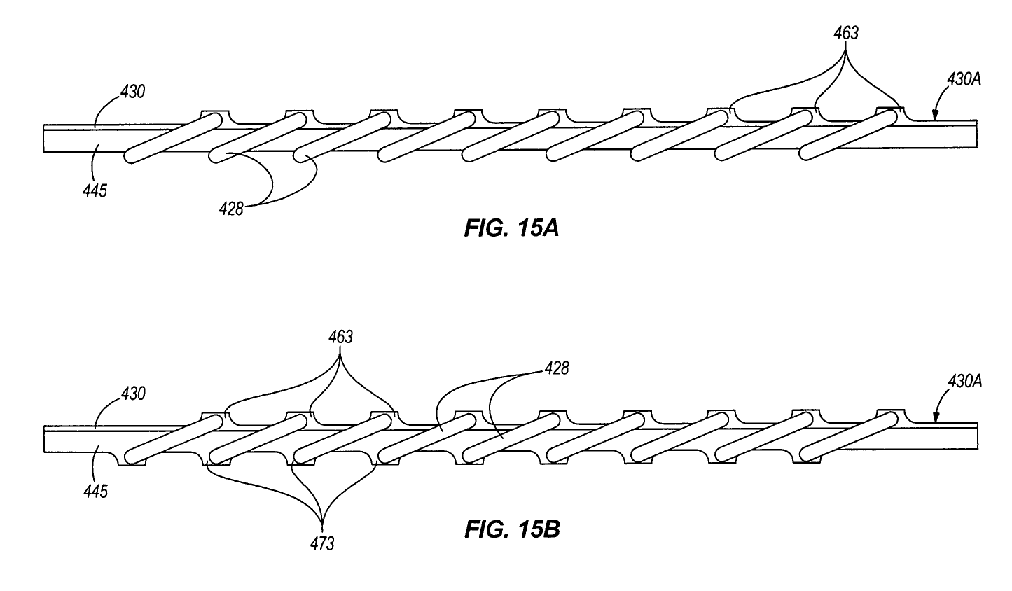

FIGS. 14A-15B illustrate variations on the embodiments of FIGS. 11-13B. The cold plate 410 can include heat pipes with condenser portions that extend across substantially the entire length of the top plate 430. Surface irregularities, such as raised ridges 463 along the length of the top plate 430 can receive the condenser portions and provide increased surface area of the upper surface 430A of the top plate 430. An evaporator portion of each of the heat pipes 428 can run along the underside of a spacer block 445, as shown in FIG. 15A. Alternately, the evaporator portions of the heat pipes 428 can be press-fit into the spacer block 445. As shown in FIG. 15B, the spacer block 445 can have surface irregularities, such as raised ridges 473 that can run the length of the spacer block 445 to receive the evaporator portions. The raised ridges 463, 473 can allow the top plate 430 and/or the spacer block 445 to be constructed of less material, reducing material costs. Furthermore, the thinner the top plate 430 is, the lighter the cold plate 410 can be made. In addition, the resistance to conduction heat transfer can be reduced by reducing plate thickness.

As shown in FIGS. 14A and 14B, the cold plate 410 can be provided with the comestible fluid inlet 414 and the comestible fluid outlet 418, both in the side of the spacer block 445. Between the inlet 414 and the outlet 418, the comestible fluid passage 450 can be positioned in a serpentine configuration back and forth. The syrup channel or passage 454 can also pass through the spacer block 445 and can either serpentine or pass substantially straight through, because the syrup generally does not require as much cooling as the comestible fluid.

The cold plate 410 of FIGS. 14A-15B can be used in a stacked or modular type configuration. Such a configuration can be similar to the cold plate 410 illustrated in FIGS. 11-13B. Stacking components can allow a smaller footprint (i.e., plan view area) and greater versatility in the number and the type of comestible fluid passages and syrup passages. In some embodiments, the cold plate 410 of FIGS. 14A-15B can be used in conjunction with a fluid chamber for additional comestible fluid, an intermediate thermal mass fluid, or flavor syrup.

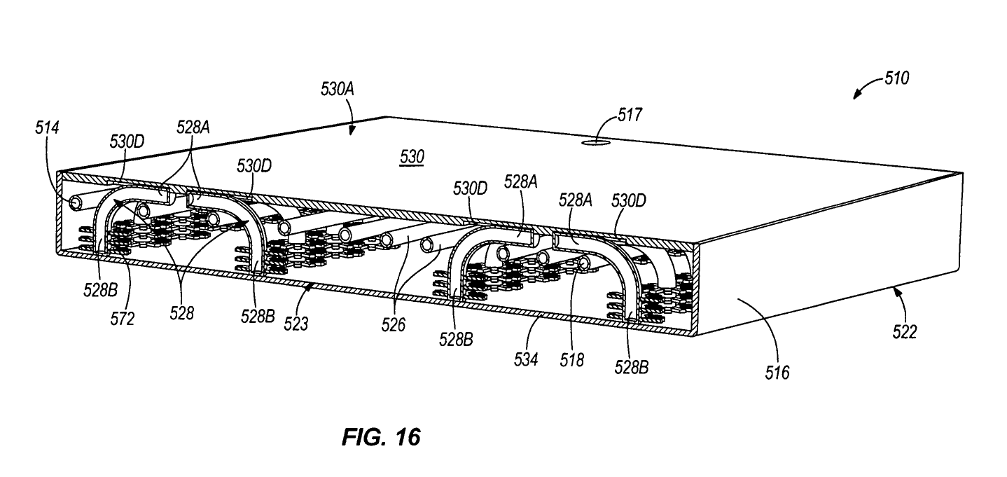

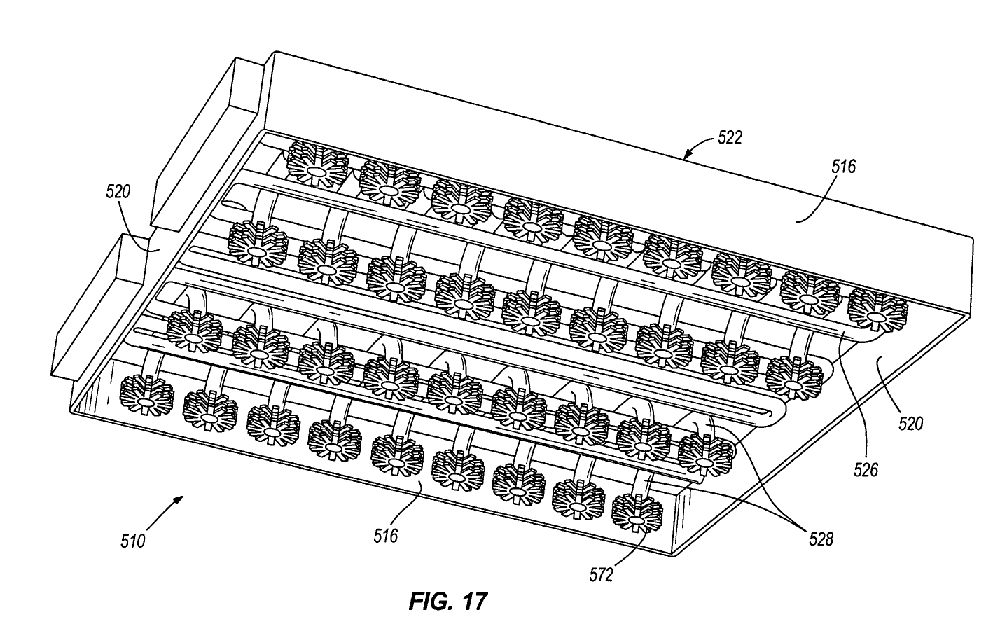

FIGS. 16-17 illustrate a cold plate 510 according to another embodiment of the invention. The cold plate 510 can be provided with heat pipes 528 inside a case 522. The case 522 can include two side walls 516, two end walls 520, and a base (or bottom plate) 534, all of which can be formed integrally, in some embodiments. However, the side walls 516, the end walls 520, and the base 534 can be formed separately and joined together by welding, threaded fasteners, epoxy, etc. A top plate 530 of the cold plate 510, along with the side walls 516, the end walls 520, and the base 534 can define the internal volume or chamber 523 of the cold plate 510. Within the chamber 523 can be contained a volume of fluid (hereinafter referred to as the intermediate fluid). A quantity of ice can be placed on an upper surface 530A of the top plate 530 as a heat sink to chill the top plate 530 to a temperature (e.g., approximately zero degrees Celsius). In some embodiments, the intermediate fluid can be water melted from the ice on top of the cold plate 510, which can drain into the chamber 523 through a drain hole 517 (as shown in FIG. 16). In other embodiments, the intermediate fluid can be pumped into the chamber 523 from an external source. The heat pipes 528 can also be located within the chamber 523. In one embodiment, eighteen pairs of heat pipes 528, each pair configured to form an inverted “U” shape, can be located within the chamber 523.

In some embodiments, each heat pipe 528 can be formed as an approximately ninety degree elbow with a generally horizontal upper leg 528A and a generally vertical lower leg 528B. The upper leg 528A can be the condenser portion of the heat pipe, which can be adjacent the top plate 530 (e.g., contacting the top plate 530 in a recess 530D). The recesses 530D can reduce the thickness of the top plate 530, and therefore reduce the local resistance to thermal conduction between the heat pipes 528 and the heat sink. The lower leg 528B can be the evaporator portion of each heat pipe 528, which can extend away from the top plate 530 and into the chamber 523. In some embodiments, one or more spur-like annular fins 572 can be arranged at or near the lower leg 528B of some or each heat pipe 528 (e.g., at the lowermost end of the lower leg 528B). The fins 572 can provide extra heat transfer capability for the heat pipes 528.

Each heat pipe 528 can accept heat from the intermediate fluid in the chamber 523, which can experience a temperature drop as the heat is transferred through the heat pipes 528 to the ice. The chilled intermediate fluid can accept heat from comestible fluid that can be contained by a comestible fluid line 526 within the chamber 523 and immersed in the intermediate fluid. In some embodiments, the comestible fluid line 526 can be a single line, which can be positioned in a serpentine configuration through the chamber 523. In some embodiments, several comestible fluid lines 526 can pass through the chamber 523 and may or may not be positioned in a serpentine configuration through the chamber 523.

In some embodiments, the heat pipes 528 can be constructed of copper. The intermediate fluid can provide the thermal capacitance for the cold plate 510, allowing a vast mass reduction compared to aluminum-block cold plates. Because the comestible fluid can be contained within the comestible fluid line 526, which can be constructed of stainless steel or a relatively conductive plastic, the intermediate fluid and heat pipes 528 need not be especially sanitary. This can reduce the manufacturing and assembly effort required to meet the constraints for comestible handling surfaces.

In some embodiments, the heat pipes 528 can be overmolded with a layer of plastic or another material that is suitable for contact with comestibles. The chamber 523 of the cold plate 510 can then contain the comestible fluid, substantially or entirely eliminating the need for the intermediate fluid and the comestible fluid line 526 through the chamber 523. In some embodiments, the heat pipes 528 do not have any fins. In some embodiments, the plastic layer over the heat pipes 528 can include surface irregularities (e.g., ridges, fins, dimples, etc.) to enhance the thermal conductivity of the plastic layer. Syrup lines are not shown in FIGS. 16 and 17, but can be used according to other embodiments of the invention, as described above, for providing chilled and/or ambient temperature flavor syrups to a dispense tap.

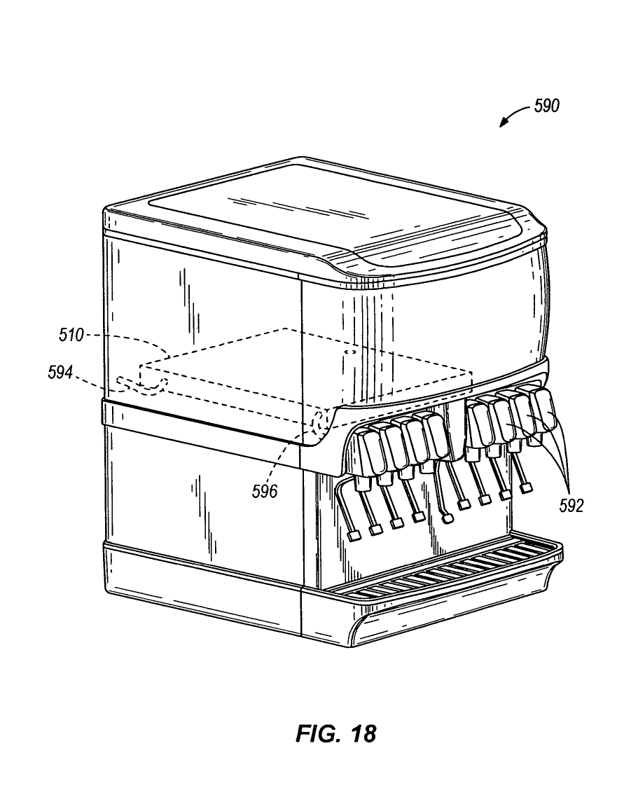

FIG. 18 illustrates a beverage dispensing system 590 incorporating the cold plate 510. The dispenser 590 can be provided with one or more dispense heads 592. In some embodiments, the comestible fluid (e.g., water) can be mixed with a flavored syrup before being dispensed. A comestible fluid supply line 594 can be coupled to the fluid inlet 514 of the cold plate 510 and can put the cold plate 510 into fluid communication with a comestible fluid source (not shown). A comestible fluid delivery line 596 can be coupled to the fluid outlet 518 of the cold plate 510 and can put the cold plate 510 into fluid communication with one or more dispense heads 592. The cold plates of all of the embodiments of the invention described above can also be configured for use with the beverage dispensing system 590. Integration of a cold plate according to an embodiment of the invention into a beverage dispenser can include additional inlets and outlets for fluids including, but not limited to, comestible fluids and flavored syrup(s).

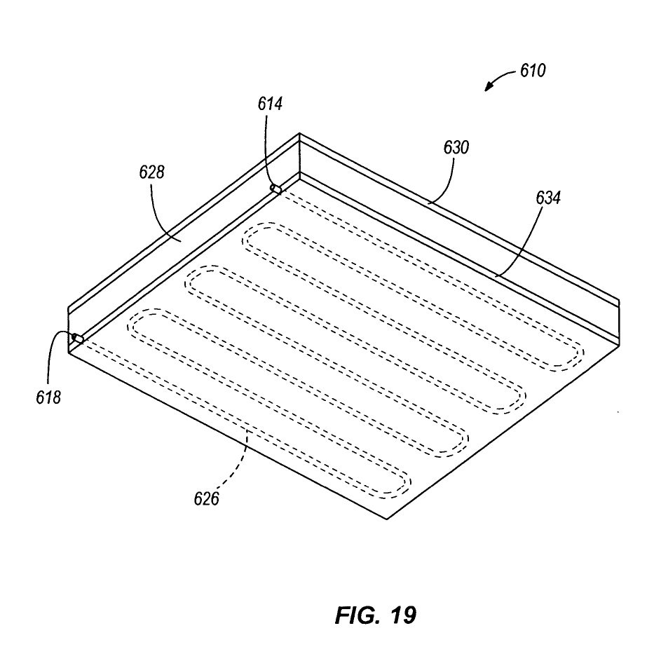

FIG. 19 illustrates a cold plate 610 according to another embodiment of the invention. The cold plate 610 can include a top plate 630 and a base or bottom plate 634. In some embodiments, the top plate 630 and the bottom plate 634 can be arranged parallel to each other. A heat pipe 628 can be positioned between the top plate 630 and the bottom plate 634. In some embodiments, the bottom plate 634 can include a comestible fluid line 626 (as shown in FIG. 19). The comestible beverage line 626 can be provided with a comestible fluid inlet 614 and a comestible fluid outlet 618. The comestible fluid inlet 614 can be configured to flow a comestible fluid from a comestible fluid supply (not shown) to the cold plate 610. The comestible fluid outlet 618 can be configured to flow comestible liquid from the cold plate 610 to a dispense head of a beverage dispensing system (not shown).

The heat pipe 628 can be configured with an internal structure similar to that described above. In the illustrated embodiment, the heat pipe 628 can define an interior volume with a substantially similar footprint as the top plate 630 and/or bottom plate 634. An upper surface of the heat pipe 628 can be positioned to contact a bottom surface of the top plate 630 across substantially an entire surface area thereof. As such, a condenser portion of the heat pipe 628 can be provided, which is approximately the entire size of the top plate 630 (which can be positioned for contact with ice). Likewise, a lower surface of the heat pipe 628 can be positioned to contact an upper surface of the bottom plate 634 across substantially an entire surface area thereof. The comestible fluid line 626 can be positioned within the bottom plate 634 or can be partially defined by the bottom plate 634. In some embodiments, comestible fluid can flow directly on the lower surface of the heat pipe 628 to efficiently transfer heat to an evaporator portion of the heat pipe 628.

In operation of a beverage dispenser, the cold plates of embodiments of the invention can deliver approximately ⅚ the volume of a “mixed” dispensed beverage (e.g., including water and flavored syrup). Therefore, the cold plate can be configured to deliver a desired comestible fluid flow rate between zero fluid ounces per minute and 300 fluid ounces per minute. The performance of the cold plate is, in some respects, also related to the temperature drop in the comestible fluid that the cold plate can achieve. In some embodiments, the cold plate is configured to produce a temperature drop in the comestible fluid between the fluid inlet and the fluid outlet between about zero degrees Celsius and 30 degrees Celsius. In some embodiments, an overall heat transfer coefficient-area product is about 550 watts/K. One example of a specific operating condition includes flowing 256 fluid ounces of comestible fluid per minute through the cold plate and achieving a temperature drop of 22 degrees Celsius (e.g., from 25 degrees Celsius to 3 degrees Celsius). In some embodiments, the cold plate can produce the above noted fluid delivery specifications with a pressure drop across the cold plate (e.g., between the fluid inlet and the fluid outlet) of not more than about 15 psi. In some embodiments, the cold plate can produce the above noted fluid delivery specifications with a pressure drop across the cold plate of less than one psi.

In some embodiments, the cold plate can have a footprint (i.e., the area occupied in plan view) of about 20 inches by 24 inches or less. In some embodiments, the cold plate can have a footprint of about 17 inches by 20 inches or less. In some embodiments, the cold plate can have a footprint of about 12 inches by 16 inches or less. In some embodiments, the cold plate can have a dry weight (i.e., not filled with any liquid) of 50 pounds or less. In some embodiments, the cold plate can have a dry weight of about 20 pounds or less. In some embodiments, the cold plate can have a dry weight of about 12-18 pounds. The performance and size specifications described above apply to all the embodiments described herein and further constructions of the invention not shown or described in detail herein.

Thus, the invention provides, among other things, a cold plate for use in a beverage dispenser with increased thermal effectiveness (i.e., heat transfer efficiency, heat transfer rate, etc.) and reduced mass. Various features and advantages of the invention are set forth in the claims.

1. A cold plate for cooling a dispensable liquid, the cold plate comprising:
a plate including at least one surface for contact with a low temperature heat sink; and
a heat pipe in heat transfer relationship with the plate and the dispensable liquid.

2. The cold plate of claim 1, further comprising a liquid inlet and a liquid outlet, wherein a temperature of the liquid at the liquid outlet is between about zero degrees Celsius and about 4.4 degrees Celsius.

3. The cold plate of claim 2, wherein a liquid temperature at the liquid inlet is up to 32.2 degrees Celsius, and wherein the cold plate is configured to dispense between about zero and about 300 fluid ounces of the liquid per minute.

4. The cold plate of claim 3, wherein the cold plate is configured to chill the liquid between the liquid inlet and the liquid outlet by a net temperature of about 22 degrees Celsius at a flow rate of about 256 fluid ounces per minute.

5. The cold plate of claim 1, wherein the cold plate is configured to chill the liquid at a rate sufficient to enable a dispense rate up to about 300 fluid ounces per minute.

6. The cold plate of claim 1, wherein the cold plate weighs between about 16 pounds and about 50 pounds in a dry state.

7. The cold plate of claim 2, wherein a pressure differential in the liquid between the liquid inlet and the liquid outlet is less than about 15 pounds per square inch.

8. The cold plate of claim 2, wherein a pressure differential in the liquid between the liquid inlet and the liquid outlet is between about zero pounds per square inch and about eight pounds per square inch.

9. The cold plate of claim 1, wherein the heat pipe includes an outer surface constructed of a material including stainless steel.

10. The cold plate of claim 1, wherein the heat pipe includes an outer surface constructed of a material including copper.

11. The cold plate of claim 1, wherein the heat pipe has a generally round cross-section.

12. The cold plate of claim 1, wherein the heat pipe has a generally rectangular cross-section.

13. The cold plate of claim 12, wherein the heat pipe has a square cross-section with sides of about one inch.

14. The cold plate of claim 1, wherein the plate is constructed of a material including stainless steel.

15. The cold plate of claim 1, wherein the plate is constructed of a material including aluminum.

16. The cold plate of claim 1, further comprising a liquid flow passage within the cold plate, the liquid flow passage constructed of a material including at least one of stainless steel and a polymer.

17. The cold plate of claim 16, wherein the polymer is a thermal plastic.

18. The cold plate of claim 17, wherein the thermal plastic conducts heat more effectively in a first direction than in a second direction, the second direction being orthogonal to the first direction, and wherein the liquid flow passage is positioned such that the first direction is orthogonal to the plate.

19. The cold plate of claim 1, further comprising an integrated carbonator module.

20. A cold plate for cooling comestible fluid, the cold plate comprising:
a top plate for supporting a heat sink and maintaining a temperature substantially the same as the heat sink;
a plurality of heat pipes, each one of the plurality of heat pipes including a condenser portion adjacent the top plate and an evaporator portion substantially opposite the condenser portion; and
a buffer between an adjacent pair of the plurality of heat pipes, the buffer at least partially defining a comestible fluid flow path through the cold plate.

21. The cold plate of claim 20, further comprising a base plate arranged substantially parallel to the top plate and spaced a first distance from the top plate, and wherein the buffer extends a second distance generally perpendicular from the base plate, the second distance being less than the first distance.

22. The cold plate of claim 21, wherein each of the plurality of heat pipes is coupled to a lower side of the top plate and the comestible fluid flow path is at least partially defined by a plurality of spaces between each of the plurality of heat pipes and the base plate.

23. The cold plate of claim 22, wherein the plurality of spaces are configured to increase a comestible fluid velocity in order to enhance turbulence and a local heat transfer coefficient between the comestible fluid and the evaporator portion of each of the plurality of heat pipes.

24. The cold plate of claim 21, wherein the base plate and the buffer are integrally molded.

25. The cold plate of claim 20, wherein each of the plurality of heat pipes is constructed with an outer vessel wall having a rectangular cross-section and constructed of a material including stainless steel.

26. The cold plate of claim 20, wherein each of the plurality of heat pipes is elongated parallel to a first axis and comestible fluid within the cold plate is configured to flow substantially transverse to the first axis.

27. The cold plate of claim 20, wherein the buffer comprises a flavored syrup line elongated along an axis parallel to the plurality of heat pipes.

28. A cold plate for cooling comestible fluid, the cold plate comprising:
a plate in contact with a heat sink;
a base parallel to the plate and spaced a distance from the plate; and
a plurality of heat pipes positioned between the plate and the base;
at least one of the plurality of heat pipes including upper notches adjacent to the plate and lower notches adjacent to the base, the upper notches and the lower notches defining at least part of a comestible fluid flow path through the cold plate.

29. The cold plate of claim 28, wherein each of the plurality of heat pipes is elongated along parallel axes and a comestible fluid flows transverse to the parallel axes.

30. The cold plate of claim 29, further comprising a baffle positioned between a pair of the plurality of heat pipes, the baffle including at least one syrup line extended along the parallel axes.

31. The cold plate of claim 28, wherein the plurality of heat pipes, the plate, and the base are each constructed of a material suitable for contact with comestibles.

32. The cold plate of claim 1, wherein the plurality of heat pipes are constructed of a material including stainless steel.

33. The cold plate of claim 31, wherein the plurality of heat pipes constructed of a material including a thermally conductive metal and are substantially overmolded with a polymeric overmold material.

34. The cold plate of claim 28, wherein the plurality of heat pipes include surface irregularities in order to enhance a rate of heat transfer between the plurality of heat pipes and the comestible fluid.

35. The cold plate of claim 28, further comprising a case coupled to the plate to substantially enclose the plurality of heat pipes, and wherein the case is integrally molded to include a base and four walls.

36. The cold plate of claim 35, wherein the case is coupled to a carbonator module.

37. The cold plate of claim 28, wherein the upper notches and the lower notches of adjacent ones of the plurality of heat pipes define a comestible fluid flow path that flows over a first of the plurality of heat pipes and flows under a second of the plurality of heat pipes.

38. The cold plate of claim 28, wherein at least one flavored syrup line is coupled to an underside of the base.

39. A cold plate for cooling a comestible fluid, the cold plate comprising:
a top plate that is ice-cooled;
a second plate located a distance below the top plate and substantially parallel to the top plate;
a comestible fluid passage between the top plate and the second plate; and
at least one heat pipe with at least a portion of the at least one heat pipe being in heat transfer relationship with the top plate and the second plate.

40. The cold plate of claim 39, wherein the comestible fluid passage is at least partially defined by a plastic mold.

41. The cold plate of claim 40, wherein the plastic mold defines a distance between the top plate and the second plate.

42. The cold plate of claim 39, wherein the at least one heat pipe includes an evaporator portion and a condenser portion, the condenser portion being press-fit into the top plate between a first upper surface and a first lower surface of the top plate, the evaporator portion being press-fit into the second plate between a second upper surface and a second lower surface of the second plate to provide a relatively isothermal connection between the top plate and the second plate.

43. The cold plate of claim 39, further comprising at least one syrup passage positioned below the second plate.

44. The cold plate of claim 43, wherein the cold plate further comprises:
a third plate spaced a distance below the second plate by a second plastic mold; and
at least one second heat pipe with at least a portion of the at least one second heat pipe being in contact with the top plate and the third plate.

45. The cold plate of claim 44, wherein the second plastic mold includes a substantially serpentine comestible fluid flow path.

46. The cold plate of claim 44, wherein the at least one syrup passage is coupled to a bottom of the third plate.

47. The cold plate of claim 39, wherein the at least one heat pipe forms a loop by extending between the top plate and the second plate on two opposite sides.

48. The cold plate of claim 39, wherein the at least one heat pipe forms a C shape by extending between the top plate and the second plate on a single side.

49. The cold plate of claim 39, wherein the top plate and the second plate are constructed of a material including aluminum, and wherein the at least one heat pipe includes an outer vessel wall constructed of a material including copper.

50. The cold plate of claim 49, wherein a layer of a polymeric mold material substantially covers a lower surface of the top plate and an upper surface of the second plate to at least partially define the comestible fluid passage.

51. The cold plate of claim 39, wherein the top plate and the second plate are constructed of a material including stainless steel and each of the top plate and the second plate at least partially define the comestible fluid passage.

52. A cold plate for cooling a comestible fluid, the cold plate comprising:
a top plate that is ice-cooled;
a molded block positioned below the top plate;
a comestible fluid flow passage formed in the molded block; and
at least one heat pipe in heat transfer relationship with the top plate and the molded block.

53. The cold plate of claim 52, wherein the top plate includes surface irregularities in an upper surface.

54. The cold plate of claim 53, wherein the surface irregularities includes raised ridges configured to accept a portion of the at least one heat pipe.

55. The cold plate of claim 52, wherein the molded block includes raised ridges configured to accept a portion of the at least one heat pipe.

56. The cold plate of claim 52, wherein the at least one heat pipe includes an outer vessel wall constructed of a material including copper.

57. The cold plate of claim 52, wherein the at least one heat pipe includes an outer vessel wall having a substantially round cross-section.

58. The cold plate of claim 52, wherein the comestible fluid flow passage is substantially serpentine through at least a portion of the molded block.

59. The cold plate of claim 52, further comprising a syrup flow passage integrally formed within the molded block.

60. The cold plate of claim 52, wherein the top plate is constructed of a material including aluminum.

61. A cold plate for cooling a comestible fluid, the cold plate comprising:
a plate in contact with a heat sink;
a chamber partially defined by the plate;
a liquid within the chamber;
a comestible fluid line positioned at least partially within the chamber; and
a heat pipe positioned to transfer heat from the comestible fluid to the plate via the liquid.

62. The cold plate of claim 61, wherein the comestible fluid line is constructed of a material including a polymeric material.

63. The cold plate of claim 61, wherein the comestible fluid line is constructed of a material including stainless steel.

64. The cold plate of claim 61, wherein the heat pipe includes an outer vessel wall constructed of a material including copper.

65. The cold plate of claim 61, wherein the heat pipe includes a condenser portion adjacent to the plate and an evaporator portion extending away from the plate.

66. The cold plate of claim 65, wherein the heat pipe includes an approximately 90 degree bend between the condenser portion and the evaporator portion.

67. The cold plate of claim 65, wherein the heat pipe includes at least one fin coupled to the evaporator portion in order to increase the heat transfer capability between the heat pipe and the liquid.

68. The cold plate of claim 65, wherein the at least one fin is generally spur-shaped.

69. The cold plate of claim 65, wherein the plate includes a recess in an underside portion, the recess configured to receive the condenser portion of the heat pipe.

70. The cold plate of claim 61, wherein the comestible fluid line is substantially serpentine through at least a portion of the chamber.

71. The cold plate of claim 61, wherein the plate is constructed of a material including stainless steel.

72. A beverage dispenser for cooling a comestible fluid and dispensing at least one liquid beverage containing the comestible fluid, the beverage dispenser comprising:
an interior volume for containing ice;
a cold plate positioned at least partially within the interior volume, the cold plate including a heat pipe to exchange heat energy between the comestible fluid and the ice; and
at least one dispense head for dispensing the at least one liquid beverage.

73. The beverage dispenser of claim 72, further comprising a comestible fluid supply line coupling a supply of comestible fluid to a fluid inlet of the cold plate.

74. The beverage dispenser of claim 72, further comprising a comestible fluid delivery line coupling a fluid outlet of the cold plate to the at least one dispense head.

75. The beverage dispenser of claim 72, further comprising a comestible fluid line within the cold plate for directing a flow of the comestible fluid between a fluid inlet and a fluid outlet of the cold plate.

76. The beverage dispenser of claim 75, wherein the comestible fluid line creates a substantially serpentine path between the fluid inlet and the fluid outlet.

77. The beverage dispenser of claim 70, wherein the cold plate includes a first metallic plate thermally connected to a second metallic plate by the heat pipe.

78. The beverage dispenser of claim 77, wherein a comestible fluid flow path is at least partially formed between the first metallic plate and the second metallic plate.

79. The beverage dispenser of claim 70, wherein the cold plate includes an intermediate liquid for transferring heat between the comestible fluid and the ice.

80. The beverage dispenser of claim 70, wherein the heat pipe includes an outer vessel wall of generally rectangular cross-section, the outer vessel wall having notches formed in at least one of an upper surface and a lower surface.

81. The beverage dispenser of claim 80, wherein the notches of the outer vessel wall at least partially define a serpentine comestible fluid flow path through the cold plate.

82. The beverage dispenser of claim 70, wherein the heat pipe extends from a first plate in contact with the ice toward a second plate spaced from the first plate.

83. The beverage dispenser of claim 82, wherein a space between the heat pipe and the second plate increases the velocity of the comestible fluid.

84. The beverage dispenser of claim 82, further comprising a baffle extending from the second plate toward the first plate, the baffle redirecting the comestible fluid flow direction by approximately 180 degrees from an upstream side of the baffle to a downstream side of the baffle.

85. A method of cooling a comestible fluid, the method comprising:
cooling a first plate with ice;
providing a heat pipe with a condenser portion adjacent the first plate and an evaporator portion adjacent the comestible fluid, the heat pipe drawing heat energy from the comestible fluid into at least one of the first plate and the ice; and
transferring heat from the comestible fluid to the first plate through the heat pipe.

86. The method of claim 85, further comprising:
providing a chamber for containing an intermediate liquid; and
transferring heat from the comestible fluid to the evaporator portion of the heat pipe through the intermediate liquid.

87. The method of claim 85, further comprising:
providing a second plate spaced a distance from the first plate;
isothermally connecting the first plate to the second plate via a heat pipe; and
flowing comestible fluid between the first plate and the second plate.

88. The method of claim 87, further comprising:
flowing the comestible fluid through a molded plastic beverage channel between the first plate and the second plate; and
transferring heat from the comestible fluid to at least one of the first plate and the second plate.

89. The method of claim 85, further comprising inducing turbulent flow in the comestible fluid with at least one baffle adjacent to the heat pipe.

90. The method of claim 85, further comprising throttling the comestible fluid to increase the flow velocity of the comestible fluid across at least one of the heat pipe and the first plate.
